(19) United States
(12) Patent Application Publication
(10) Pub. No.: US 2023/0292970 A1
(43) Pub. Date: Sep. 21, 2023

(54) COMPACT DUST BAG FOR A VACUUM CLEANER

(71) Applicant: Aktiebolaget Electrolux, Stockholm (SE)

(72) Inventors: Peter Mian, Stockholm (SE); Jens Leffler, Stockholm (SE); Christoffer Sörmark, Stockholm (SE)

(73) Assignee: Aktiebolaget Electrolux, Stockholm (SE)

(21) Appl. No.: 18/020,333

(22) PCT Filed: Aug. 20, 2020
(86) PCT No.: PCT/EP2020/073427

§ 371 Date: Feb. 8, 2023

(51) Int. Cl. A47L 9/14; A47L 9/12; B01D 46/02; B01D 46/00

(52) U.S. Cl. CPC A47L 9/1436; A47L 9/127; B01D 46/0005; B01D 46/02; B01D 2265/06; B01D 2271/02; B01D 2273/30; B01D 2275/203; B01D 2279/55

(57) ABSTRACT

A vacuum cleaner dust bag having a connector plate comprising a hole section, an air permeable filter bag positioned on a downstream side of the connector plate, and a flexible sleeve. The filter bag is attached to the connector plate and the sleeve is provided outside the filter bag. The sleeve is arranged to keep the filter bag in an initial folded position and allow the filter bag to expand when air is blown through a hole formed in the hole section of the connector plate.

### TECHNICAL FIELD

The present disclosure relates to a dust bag for a vacuum cleaner and to a vacuum cleaner holding the dust bag.

### BACKGROUND

Dust bags are provided in vacuum cleaners. A dust bag is typically formed by an air-permeable filter material that allows dust laden air to be blown through the dust bag and where the filter material filters out dust from the air which then remains in the dust bag.

Also, US 10,531,772 describes a hand held vacuum cleaner having a filter for filtering debris flowing through the vacuum cleaner.

There is a constant desire to improve dust bags and filters for vacuum cleaners to make them more user-friendly.

### SUMMARY

One object of the present disclosure is therefore to provide a dust container that can be more efficiently used with, in particular, compact vacuum cleaners. This object is achieved by a dust container as set out in the appended claims.

As has been realized by the inventors, it would be advantageous to avoid or reduce contact with dust and dust flying around when handling dust bags. At the same time emptying or replacement of dust bags should be facilitated to encourage more frequent cleaning or replacement of filter media in the dust bag which would improve the efficiency of the vacuum cleaner.

In accordance with a first aspect of the invention, a dust bag for a vacuum cleaner is provided. The dust bag comprises a filter bag of an air-permeable material and a front connector plate comprising a hole section. The dust bag further comprises a sleeve of a flexible material. The filter bag is attached to the front connector plate and the sleeve is provided outside the filter bag. The sleeve is arranged to keep the filter bag in a folded position and the sleeve is arranged to allow the filter bag to expand when air is blown through a hole formed in the hole section of the front connector plate. Hereby a compact dust bag can be provided that is small, compact and easy to handle before use and which when placed in a vacuum cleaner and air is blown through the filter bag of the dust bag is able to expand by the sleeve releasing the filter bag by the force exerted by the air blown through the dust bag by the vacuum cleaner. Finally, the sleeve can act as a hygienic grip when removing the dust bag from the vacuum cleaner after use for replacement or emptying of the dust bag. The sleeve thus has multiple functions that combine to obtain a user-friendly dust bag.

In accordance with one embodiment, the sleeve is formed all around the sides of the filter bag when the filter bag is in the folded position. The sleeve can then be open or closed in the end away from the front connector plate. Hereby the sleeve can completely packet the filter bag when the filter bag is in the compacted position before use prevent damage and safe handling of the filter bag of the dust bag.

In accordance with one embodiment, a guide is arranged on the front connector plate to assist in correctly positioning the dust bag in a vacuum cleaner. Such a guide can facilitate the correct placement of the dust bag in the vacuum cleaner. The guide for example be formed by a flange or aperture in the outer perimeter of the front connector plate. Such a flange can extend all around the perimeter of the front connector plate to further facilitate correction positioning.

A hole in the hole section of the front connector plate can be formed in different ways. For example, the hole can comprise a perforation in the front connector plate that can be used to form a hole in the front connector plate. In another embodiment the hole section comprises a hole in the front connector plate. The hole section can comprise a lid.

In accordance with one embodiment, the sleeve is formed by a paper material. Hereby an easy to handle and easy to recycle dust bag can be obtained.

In accordance with some embodiments the sleeve is made of a non-air permeable material. Hereby the outside of the sleeve will stay clean from dust after use and the dust bag can be removed in a hygienic way without the user having to touch the dust collected in the dust bag.

In accordance with one embodiment, the hole section is provided with a sealing to provide for an air tight connection to a vacuum cleaner when the dust bag is placed in the vacuum cleaner and a hole is opened in the dust bag.

In accordance with one embodiment, the filter bag does not extend further than the front connector plate as seen in a direction perpendicular to the axial direction of the front connector plate.

In accordance with one embodiment, the sleeve is attached to the front connector plate. Hereby the sleeve will stay in place during the use of the dust bag and can then be securely be used as a grip to remove the dust bag after use.

In accordance with one embodiment, the sleeve is folded in an end distanced away from the front connector plate. Hereby an efficient and easy to manufacture mechanism for keeping the filter bag in a compacted position before use is obtained.

In accordance with a second aspect of the invention, a vacuum cleaner having a dust bag holder configured to hold the dust bag in accordance with the above is provided. The dust bag can then be placed in the vacuum cleaner and the vacuum cleaner can comprise such a dust bag whereby easy and efficient handling of the vacuum cleaner and the dust bag used in the vacuum cleaner is enabled.

In accordance with one embodiment the dust bag is placed in the dust bag holder and the vacuum cleaner is then configured to blow air through the dust bag such that air is blown axially from a hole in the front connector plate through the dust bag. Hereby air will be blown straight through from the opening hole of the dust bag when placed inside the vacuum cleaner. This will allow for easier unfolding of the filter bag.

### BRIEF DESCRIPTION OF THE DRAWINGS

FIGS. 1a - 1d show views of a vacuum cleaner with a dust bag,

FIG. 2 is a view of a dust bag,

FIG. 3 is a detailed view of a front connector plate of a dust bag,

FIG. 4 is a view illustrating a sleeve of a dust bag,

FIGS. 5a - 5b is a view illustrating a folded sleeve in accordance with a first embodiment, and in accordance with a second embodiment,

FIGS. 6a - 6b illustrate folding of a sleeve,

FIGS. 7a - 7b illustrate an alternative embodiment of a sleeve,

FIG. 8 is a view illustrating a dust bag with an expanded filter bag.

### DETAILED DESCRIPTION

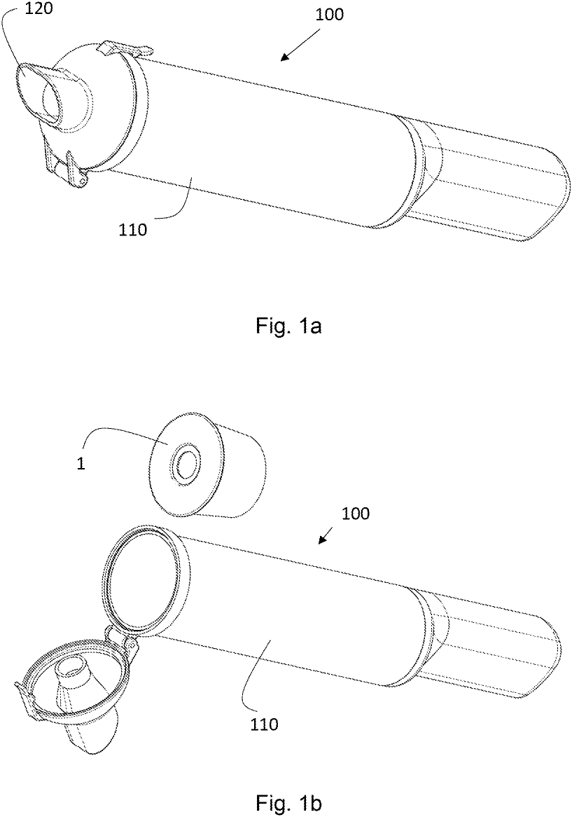

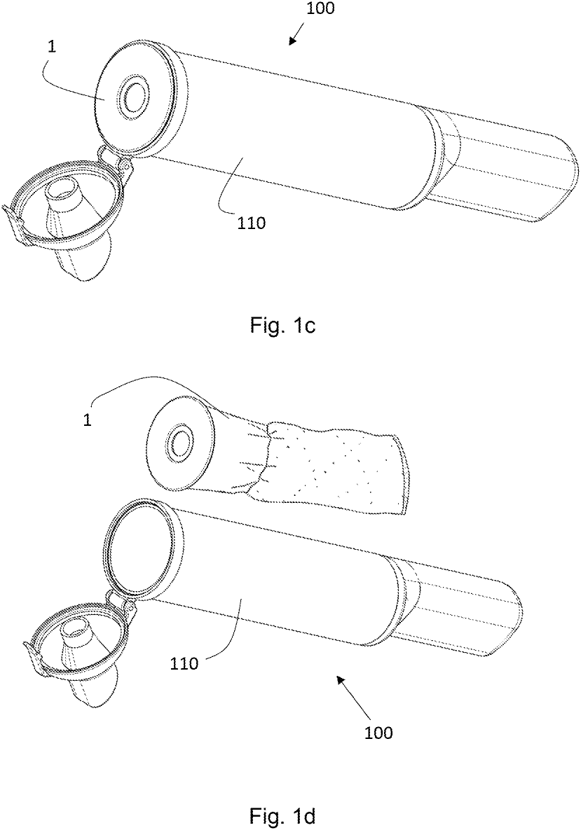

The present disclosure relates to a dust bag for a vacuum cleaner 100, as illustrated with an example in FIG. 1a. The vacuum cleaner 100 in FIG. 1a is a small handheld vacuum cleaner, but the invention is equally applicable to other types of vacuum cleaners, in particular compact vacuum cleaners where the amount of space that can be used for holding a dust bag is small. The vacuum cleaner 100 has a holder 110 for holding a dust bag. This holder 110 can also be referred to as a dust bag holder 110. The vacuum cleaner 100 has an air inlet 120 via which dust laden air can enter the vacuum cleaner when an air flow is generated by a motor (not shown) in the vacuum cleaner 100 as is generally known in the art. In FIG. 1b the holder 110 is opened to allow placing a dust bag 1 inside the vacuum cleaner 100. The dust bag 1 is of a compact type that will expand when air is blown though the center of the dust bag as will be described in more detail later.

In FIG. 1c the dust bag 1 is shown placed inside the holder 110 of the vacuum cleaner 100. Finally, in FIG. 1d the dust bag 1 is shown when removed from the holder 110 after use of the dust bag 1. As is illustrated the dust bag 1 has expanded when air has been blown through the dust bag 1.

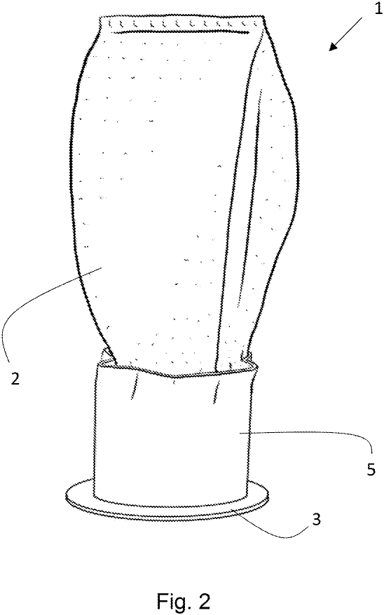

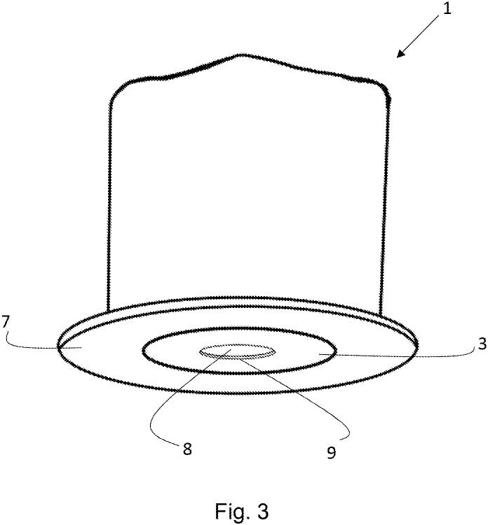

In FIG. 2 a more detailed view of the dust bag 1 is shown. The dust bag 1 is made of an air permeable filter material, as is well known per se. A front connector plate 3 is attached to the dust bag 5, for instance by being glued thereto, and typically can have an opening coinciding with an opening in the dust bag 5, such that the opening of the front connector plate also becomes the opening of the dust bag as a whole. This is illustrated in FIG. 3. Further, a sleeve 5 is provided outside the filter bag 3. The sleeve 5 performs multiple functions when used as will be described in more detail below. The sleeve can be formed by a flexible material, such as a paper material or a textile material. In particular the sleeve 5 can be produced by a material adapted to be folded and which material stays in the folded position when no or only a relatively small outside force acts on the sleeve 5. In accordance with some embodiments the sleeve is made of a non-air permeable material. Hereby the outside of the sleeve will stay clean from dust after use and the dust bag 1 can be removed in a hygienic way without the user having to touch the dust collected in the dust bag 1.

In FIG. 3, a more detailed view in perspective of the dust bag 1 is shown illustrating the design of the front connector plate 3. The front connector plate 3 can be configured to position a hole 8 of the dust bag 1 in a correct manner in relation to an air inlet in the body of a vacuum cleaner. The hole is formed in a hole section of the connector plate 3 and can be formed in different ways. For example, the hole can comprise a perforation in the front connector plate 3. In another embodiment the hole section comprises a hole in the front connector plate 3. The hole section can also comprise a lid.

Correct positioning of the front connector plate 3 can be carried out by sliding or pushing the dust bag 1 into a holder or socket in the vacuum cleaner. The front connector plate 3 can then fix the dust bag 1 in a correct position. This operation positions the opening (hole) 8 correctly to receive a flow of dust laden air thereby entering the dust bag 1, which is capable to remove most of the dust from the air flow.

The front connector plate 3 can in accordance with some embodiments have a circular shape. Hereby the dust bag can be positioned in all directions. This can make the dust bag easy to place in the vacuum cleaner. Also, the air flow through the dust bag can be improved by making the front connector plate and or the filter bag with a circular cross section in a plane perpendicular the direction in which air is blown through the dust bag when in use. A gasket 9 may be attached to the front connector plate 3 at the opening so as to provide a sealing function, reducing leaks in the flow from an inlet to the dust bag 1. Further, to facilitate insertion of the dust bag 1 in the vacuum cleaner, the front connector plate 3 can be provided with a guide 7 arranged on the front connector plate 3 to assist in correctly positioning the dust bag in a vacuum cleaner. The guide can in accordance with some embodiments be formed by a flange or aperture in the outer perimeter of the front connector plate. The flange can extend all around the perimeter of the front connector plate 3. In other embodiments the guide can be formed by the shape of the sleeve. If the sleeve has a conical or pyramid shape the dust bag can fit easily inside a dust bin of a vacuum cleaner with a shape corresponding to the shape of the dust bag 1. In accordance with some embodiments, the front connector plate 3 can have a seal or act as a sealing between the lid and the dust bag holder.

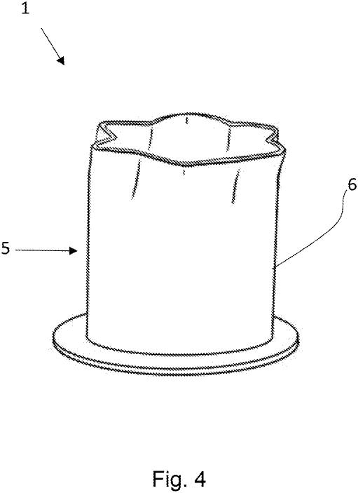

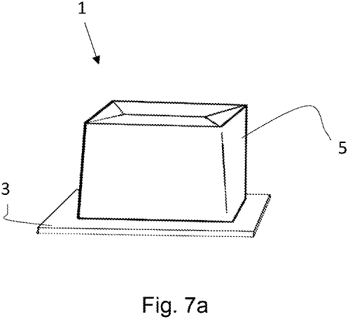

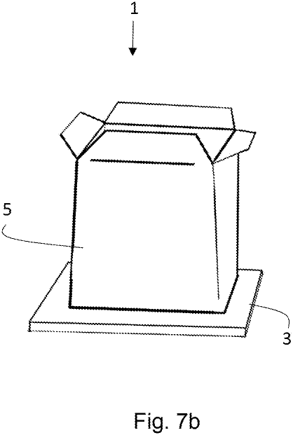

In FIG. 4, a more detailed view in perspective of the dust bag 1 is shown illustrating the design of the sleeve 5. The sleeve 5 is a bottomless cover that is designed to at least partly surround the filter bag of the dust bag 1. The sleeve 5 in FIG. 4 is generally cylinder shaped. However, it is also envisaged that the sleeve can form other geometrical shapes when expanded such as conical, pyramid or cubical shapes. In FIGS. 7a and 7b a block shaped sleeve is shown. The front connector plate can then in some embodiments be rectangular. The sleeve can be made from a number of materials, preferably non air-permeable, such as cardboard or paper, or recycled plastics. The outer walls 6 can be used as grip to avoid contact to the filter material. Hereby the dust bag can be replaced/emptied and filters can be replaced by a user without being exposed to dust.

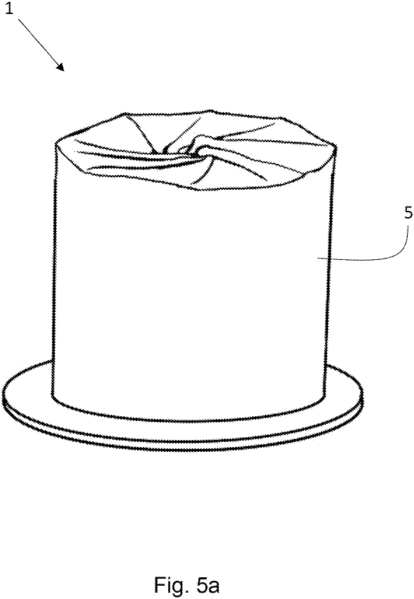

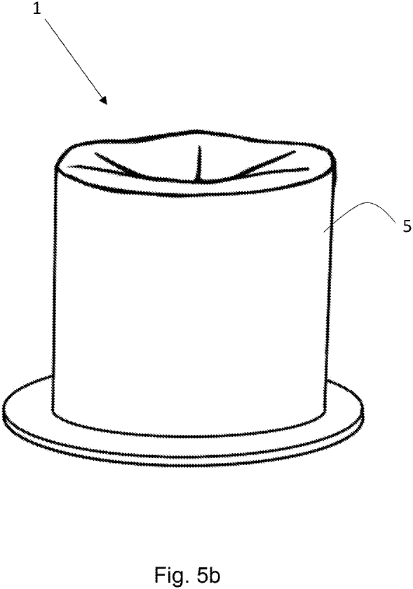

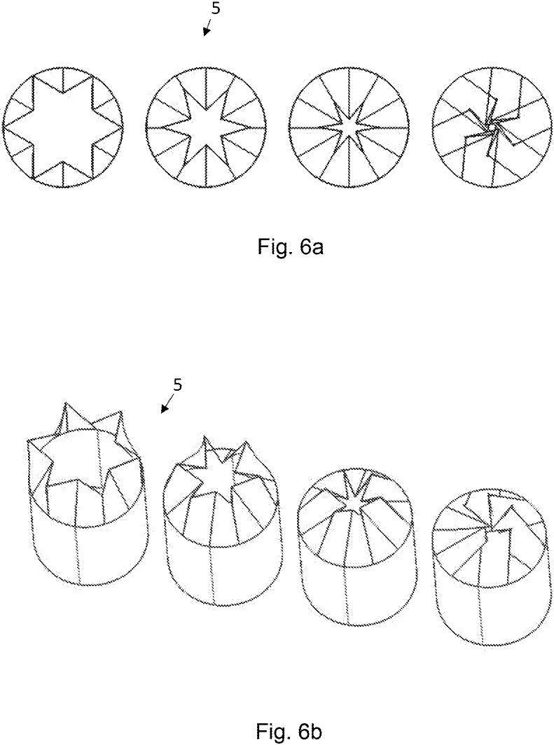

The provision of the sleeve 5 also makes it possible to compact the dust bag 1 before it is used. This is illustrated in FIGS. 5a and 5b. In FIG. 5a, a compacted dust bag 1 in accordance with the above in accordance with a first embodiment is shown. The filter bag (not visible in FIG. 5a) is compacted into a folded position. The open part of the sleeve 5 is closed to keep the filter bag 2 in its folded, compacted position. In the embodiment of FIG. 5a the sleeve is closed in its open part by folding the open part in a first pattern in which six or more corners/mountain folds are created and folded towards the middle of the sleeve opening with a slight off-set to the same side for all so that the tip of the mountain fold interlocks with the one next to it when the tips are pushed below the edge of the sleeve fold. This is further shown in FIGS. 6a and 6b where different stages of the folding of the sleeve 5 is shown in different views.

In FIG. 5b a compacted dust bag 1 in accordance with the above in accordance with a second embodiment is shown. The filter bag (not visible in FIG. 5b) is compacted into a folded position. The open part of the sleeve 5 is closed to keep the filter bag 2 in its folded, compacted position. In the embodiment of FIG. 5b the sleeve is closed in its open part by folding the open part in a second pattern in which six or more corners/mountain folds are created and is folded towards the middle of the sleeve opening. The tip of the mountain fold interlocks when they are pushed below the edge of the sleeve fold. The fold of FIG. 5b typically requires a slightly stiffer material.

Thus, the sleeve 5 is arranged to keep the filter bag in a folded position. At the same time the sleeve 5 is arranged to allow the filter bag 2 to expand when air is blown through the hole 8 formed in the hole section of the front connector plate 3 as will be described in more detail below. The dust bag is particularly well suited to allow for air to be blown in an axial direction from the hole section back towards the folded part of the sleeve 5. In other words, air is advantageously blown straight through the dust bag 1. Preferably, when the filter bag 2 is in an unfolded state, the filter bag 2 does not extend further than the front connector plate as seen in a direction perpendicular to the axial direction of the front connector plate.

In the embodiments shown in FIGS. 5a and 5b, the sleeve 5 is formed all around the filter bag 2 when the filter bag is in the folded position. However, it is also envisaged that the sleeve can be formed only partially around the filter bag 2 as long as the sleeve 5 allows for the filter bag to be kept in a folded, compacted position before air is blown through the dust bag 1. For example, in one embodiment the sleeve 5 extends over the sides of the filter bag 2. It is further envisaged that the sleeve 5 can be closed in some other ways than by folding such as by glue. In another embodiment an adhesive lid can be glued to the sleeve to retain the filter bag in the folded, compacted position before air is blown through the dust bag 1. The lid is then removed by the air blown through the filter bag and releases the filter bag. The lid can also be attached to the filter bag and glued to the sleeve.

Further, Other folding patterns can also be used to close the sleeve around the filter bag 2 when the sleeve is folded to keep the filter bag kept in the folded, compacted position before air is blown through the dust bag 1. For example edges of lids of the sleeve opening can be folded to interlock when pushed together For example, several flaps can be provided at the end of the sleeve, each flap can be folded down over the previous one until the last one is left, this one is folded under the first flap and thus locking the fold.

In FIGS. 7a and 7b, an embodiment where the sleeve 5 has a rectangular cross section and where the front connector plate is rectangular is shown. The sleeve 5 is here closed by folding flaps to lock the sleeve before use.

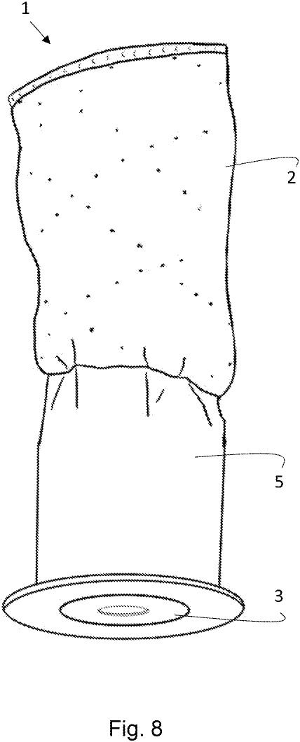

When air is blown through the hole of the front connector plate 3 of the dust bag 1, the sleeve 5 opens and allows for the filter bag 2 to expand. This is shown in FIG. 8.

By providing a dust bag in accordance with the teachings herein it possible to combine the convenience, hygienic properties and energy efficiency of a conventional dust bag solution but without the same (large) the space requirement. At the same time, it enables easier replacement of the dust bag. Moreover, the user does not need to be in contact with dust during dust bag replacement, since the sleeve can act as a grip for the user when handling the used dust bag. Before use the dust bag is reduced in size and can have a very compact format indeed. The dust bag can be used in any type of vacuum cleaner.

1. A dust bag for a vacuum cleaner comprising:
a connector plate comprising a hole section;
a filter bag of an air-permeable material positioned on a downstream side of the connector plate; and
a sleeve of a flexible material positioned on the downstream side of the connector plate outside the filter bag
wherein the sleeve is arranged to hold the filter bag in an initial folded position and allow the filter bag to expand when air is blown towards the downstream side of the connector plate through the hole section of the connector plate.

2. The dust bag according to claim 1, wherein the filter bag is connected to the connector plate at filter bag sides, and the sleeve surrounds an entirety of the sleeve sides when the filter bag is in the initial folded position.

3. The dust bag according to claim 1, further comprising a guide on the connector plate, the guide being configured -to assist in correctly positioning the dust bag in a vacuum cleaner.

4. The dust bag according to claim 3, wherein the guide is formed by a flange and/or aperture in the outer perimeter of the connector plate.

5. The dust bag according to claim 4, wherein the flange extends all around a perimeter of the connector plate.

6. The dust bag according to claim 1, wherein the hole section comprises a perforation in the connector plate, the perforation being configured to form a hole in the connector plate.

7. The dust bag according to claim 1, wherein the hole section comprises a hole in the connector plate.

8. The dust bag according to claim 1, wherein the filter bag does not extend further than the connector plate as seen in a direction perpendicular to the axial direction of the connector plate.

9. The dust bag according to claim 1, wherein the sleeve is formed by a paper material.

10. The dust bag according to claim 1, wherein the sleeve is made of a non-air permeable material.

11. The dust bag according to claim 1, wherein the hole section comprises a sealing configured to form an air tight connection to a vacuum cleaner when the dust bag is placed in the vacuum cleaner and a hole is in the hole section.

12. The dust bag according to claim 1, wherein the sleeve is attached to the connector plate.

13. The dust bag according to claim 1, wherein the sleeve is folded in an end distanced away from the connector plate.

14. A vacuum cleaner comprising a dust bag holder, wherein the dust bag holder is configured to receive a dust bag according to claim 1 .

15. A vacuum cleaner according to claim 14, wherein the dust bag is configured to be placed in the dust bag holder and wherein the vacuum cleaner is configured to blow air through the dust bag such that air is blown axially from a hole in the connector plate through the dust bag.

16. The dust bag according to claim 1, wherein the filter bag and the sleeve are connected to the connector plate.

17. The dust bag according to claim 1, wherein the sleeve comprises:
a proximal end attached to the connector plate;
sidewalls extending from the proximal end and surrounding sides of the filter bag in the initial closed position; and
a distal end extending from the sidewalls, wherein the distal end is movable from a closed position in which the distal end encloses an end of the filter bag, and an opened position in which the distal end does not enclose the end of the filter bag, and wherein the distal end is configured to move from the closed position to the open position upon application of a suction force.

18. The dust bag according to claim 17, wherein the distal end is folded in the closed position, and unfolded in the opened position.

19. The dust bag according to claim 17, wherein the distal end is held in the closed position by glue.

20. The dust bag according to claim 17, wherein the sidewalls and distal end completely enclose the entire filter bag when the filter bag is in the initial closed position and the distal end is in the closed position.
